(19) United States
(12) Patent Application Publication
(10) Pub. No.: US 2001/0012168 A1
(43) Pub. Date: Aug. 9, 2001

(54) APPARATUS WHICH PRODUCES AN AUDIBLE WARNING TONE WHEN A VIDEO TAPE IS EJECTED FROM A VCR

(76) Inventors: RAYMOND E. WESS, HOLLY, NY (US); RONALD H. KIESOW, SPENCERPORT, NY (US)

Correspondence Address: PATENT LEGAL STAFF, EASTMAN KODAK COMPANY, 343 STATE STREET, ROCHESTER, NY, 14650-2201, US

(21) Appl. No.: 09/079,954

(22) Filed: May 15, 1998

(51) Int. Cl. G11B 15/18

(52) U.S. Cl. 360/69

(57) ABSTRACT

An audio warning device is used in conjunction with a tape player for providing a warning tone when a tape has not been removed from the tape player after the tape player has ejected the tape. Provided is a tape player, a warning tone generator for generating a tone when activated, and an activation device positioned proximate the tape player and responsive to the ejection of a tape from the tape player for activating the warning tone generator when the tape is ejected from, but not removed from, the tape player.

### CROSS-REFERENCE TO RELATED APPLICATIONS

The present application is related to U.S. application Ser. No. 08/056,949, filed Apr. 08, 1998, by Raymond E. Wess, et al., and entitled, “Method and System for Capturing Images From a Video Tape for the Purpose of Creating a Motion Card.”

### FIELD OF THE INVENTION

The invention relates generally to an apparatus which emits a warning signal when a video tape is ejected from a VCR (video cassette recorder). The device is a attached to a VCR either by means of a secondary carriage or by direct attachment. The warning signal emitted by the device is used to alert the user that a video tape has been ejected by the VCR but that it has not yet been removed by the user.

### BACKGROUND OF THE INVENTION

Video tape is used to store video images recorded by a VCR or video camera. The images on the tape can be used for several purposes including general viewing as well as creating still images on photographic media. Systems which produce still images on photographic media from a video tape use VCR's to reproduce the video on a video tape for the purpose of recording the signal. A typical system for creating photographic images from video may include a computer, printer, and a VCR. Once the signal has been recorded, an images(s) can be printed by electronic means on photographic media. In addition, a sequence of multiple images can be recorded from a video tape and stored in a digital format in a computer. The images can be used to create a single composite image that when viewed behind a lenticular screen produces a hard copy motion sequence card. The process of creating a hard copy motion sequence card can be accomplished in a kiosk containing a VCR for playing the motion video sequence, a computer for capturing video images and creating a composite image, a monitor for previewing the motion sequence on the card, and a printer for making the motion sequence card.

When the motion video sequence on the video tape has been captured by the kiosk system the video tape is no longer needed. The video tape is ejected from the kiosk. It is desirable to have an audible warning tone emitted by the system for the purpose of warning the user that the tape has been ejected and is accessible for removal.

VCR's do not emit a warning tone when a video tape is ejected and remains in the VCR tape slot. This invention is a device which is external to a VCR in a kiosk and emits a warning tone to alert the user to remove the video tape from a kiosk when the video tape is ejected from a VCR residing in the kiosk.

This invention differs from an ATM which emits a warning signal when a bank card is ejected from the machine in that the warning mechanism is integral to the ATM, which is not the case for a VCR in a kiosk.

### SUMMARY OF THE INVENTION

The present invention is directed to overcoming one or more of the problems set forth above. Briefly summarized, according to one aspect of the present invention, there is provided an audio warning device for use in conjunction with a tape player for providing a warning tone when a tape has not been removed from the tape player after the tape player has ejected the tape, comprising: a tape player; means for generating an audible tone when activated; and activation means, in proximity to said tape player and responsive to the ejection of a tape from said tape player, for activating said audible tone generator when the tape is ejected from, but not removed from, the tape player.

These and other aspects, objects, features, and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the following advantages:

very low cost implementation;

auto resetable warning tone by means of mechanical interference;

insert/eject differentiation by means of a mechanical lever;

no electronic control necessary by kiosk system or VCR needed to operate warning tone; and

optional computer connection.

### BRIEF DESCRIPTION OF THE DRAWINGS

FIG. 1 is a perspective view of a kiosk that receives a video tape as an input media;

FIGS. 2A-2C are cross-sectional representations taken along the section lines A-A of FIG. 1 of the activation device that senses the load, play, and ejection positions, respectively, of a video tape used in conjunction with a VCR player integrated within a kiosk; and

FIG. 3 is a block circuit diagram of a warning tone generator activated by a switch.

To facilitate understanding of the invention identical reference numerals have been used, where possible, to designate identical elements that are common to the figures.

### DETAILED DESCRIPTION OF THE INVENTION

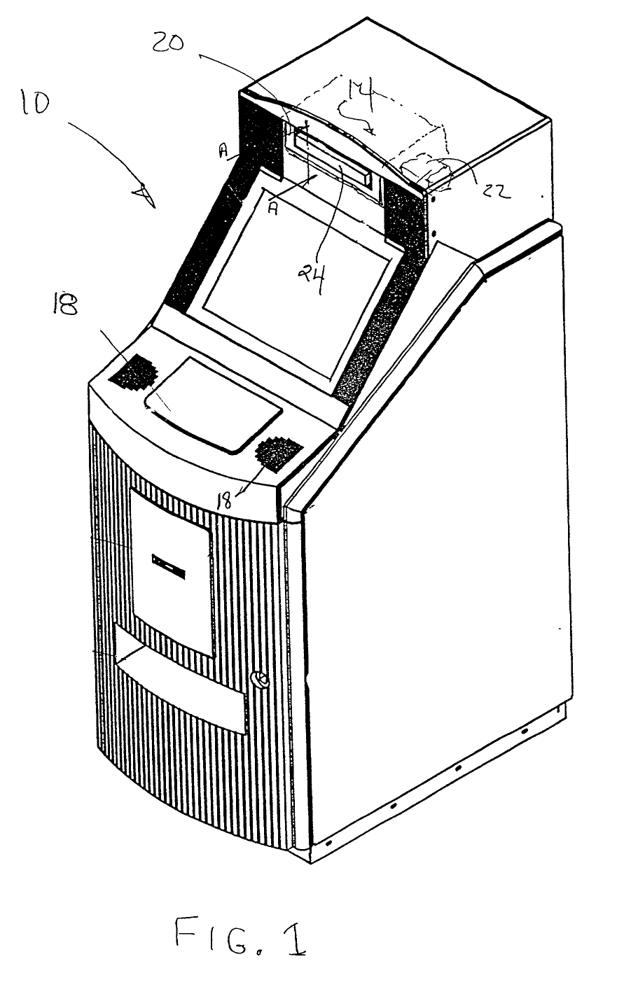

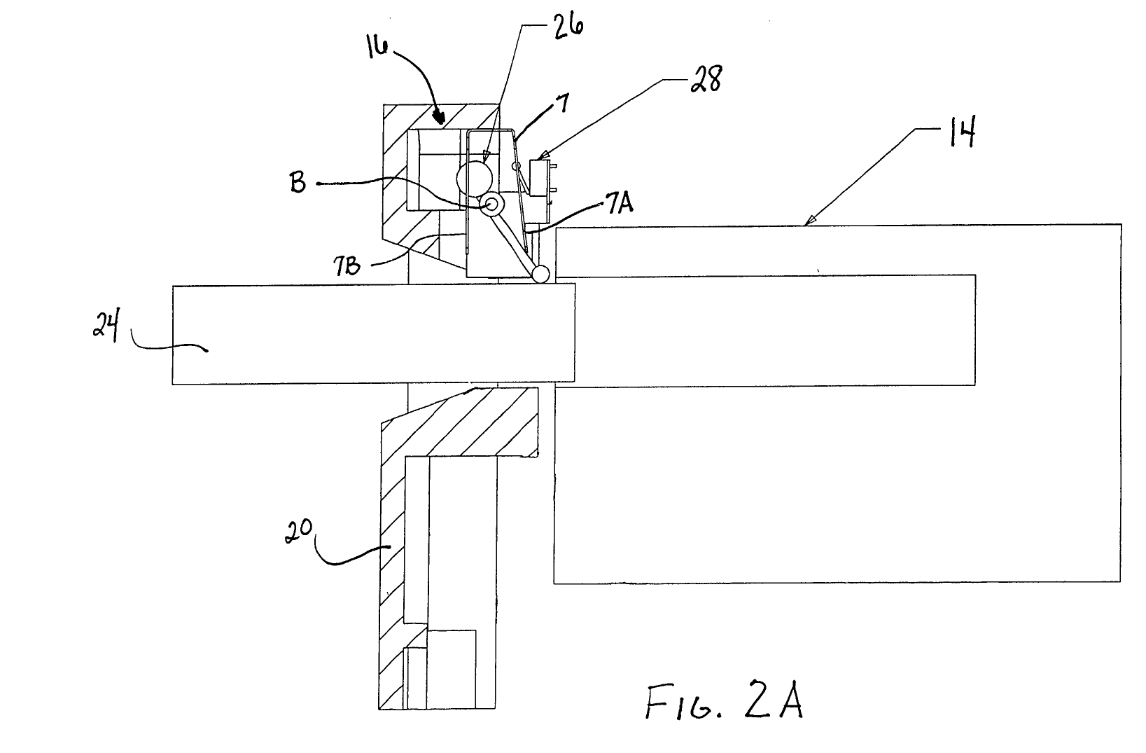

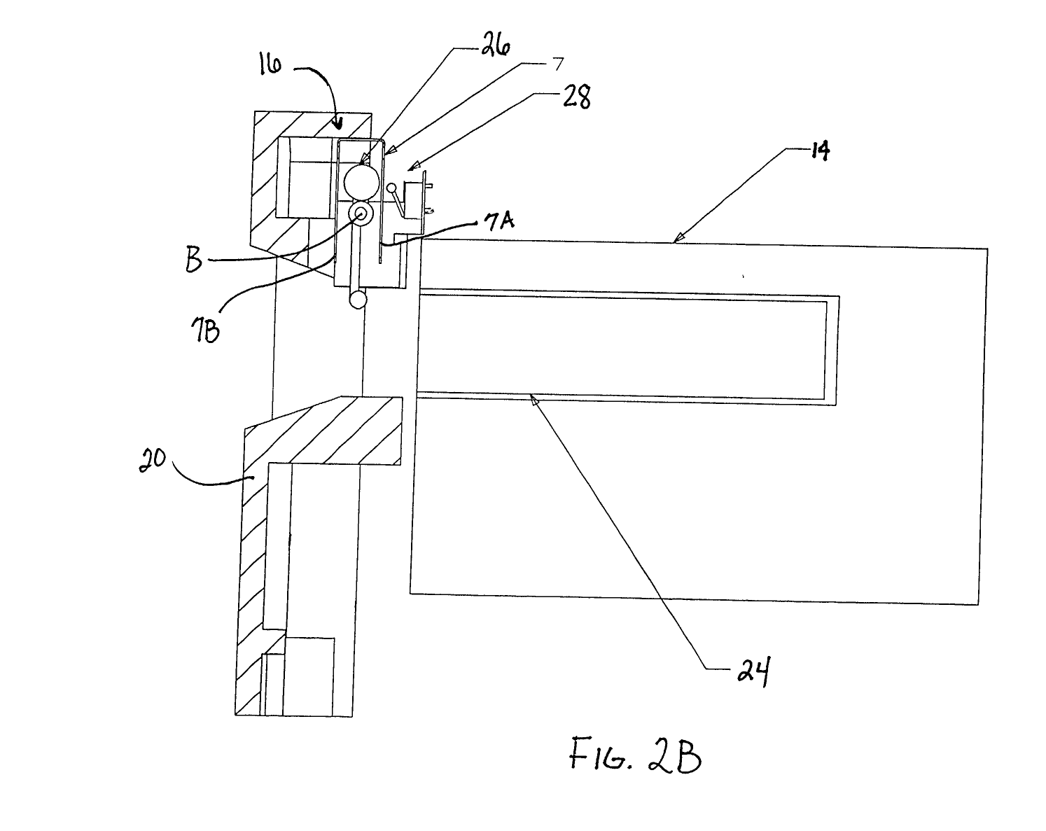

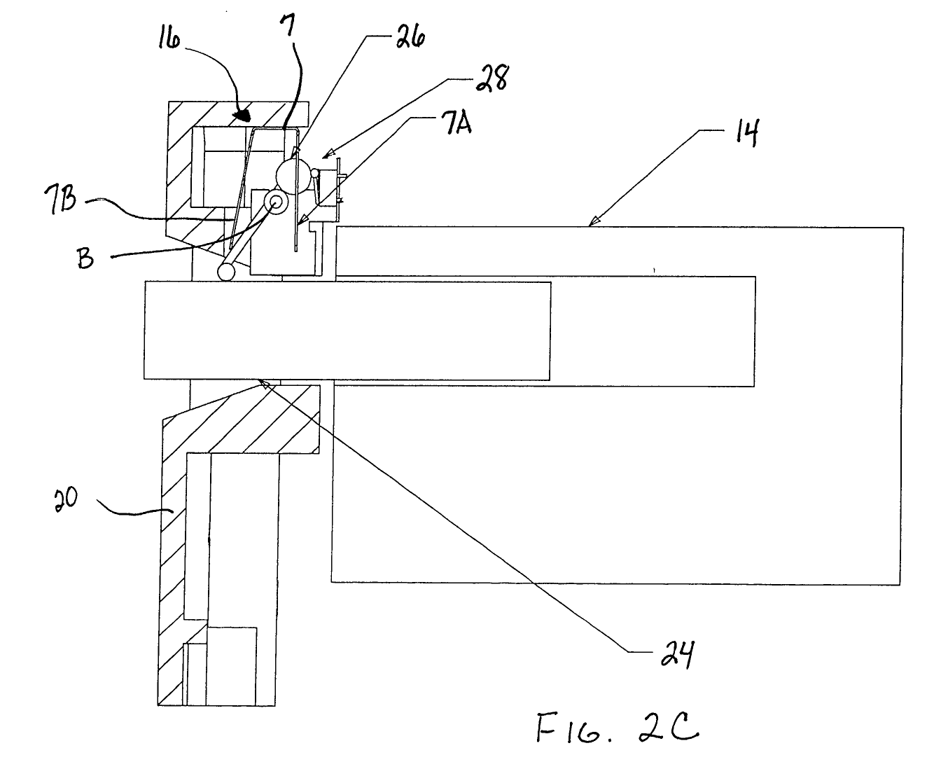

The kiosk 10 of FIG. 1 is the subject of U.S. patent application Ser. No. 08/056,949, referenced above. The system for providing the warning tone that is integrated into the kiosk 10 is comprised of a tone generator 22, shown positioned in proximity to a VCR 14, a speaker system 18 that is driven by the tone generator 22, an activation device 16 which may be, for example, a mechanical or electrically activated switch assembly as shown in FIGS. 2A, 2B, and 2C, and a face plate assembly 20 for maintaining the activation device 16 in correct operating position with respect to a video tape 24.

The warning tone system emits a warning signal when the video tape 24 is ejected from its load position in the VCR 14. The warning signal is in the form of an audible tone or verbal instruction which can be continuous, pulsed, a finite duration, or any combination thereof. The warning tone system does not have to be electrically connected to the VCR 14. The warning tone system can be connected to the kiosk's computer system for the purpose of controlling the start, duration, or operation of the warning signal, or the warning tone system can operate separate from computer control within the kiosk system to control the start, duration, or operation of the warning tone. The warning tone system only emits a warning signal when the video tape 24 is ejected from the VCR 14, and not when the video tape 24 is placed into the VCR 14. In the context of this description, when a video tape 24 is ejected from the VCR 14 it is no longer in the read or write (load) position, but it is in a position to be removed by a VCR user without further VCR operation.

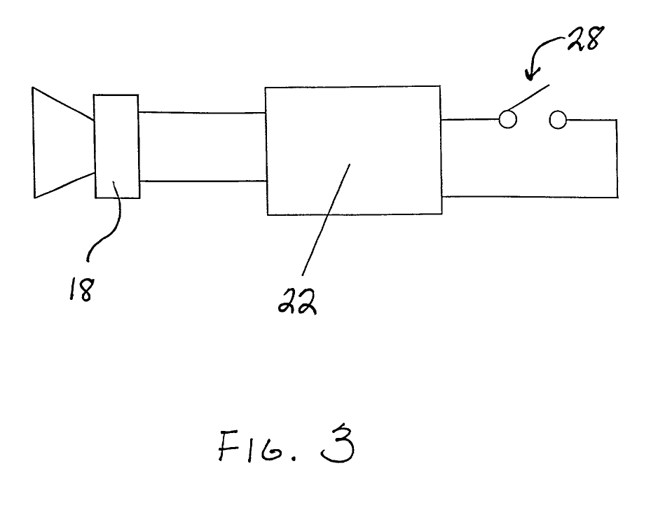

Referring now to FIG. 2A, the warning tone system is shown here more clearly in sectional view, comprised of a face plate assembly 20 that supports the switch assembly 16 that is electrically connected to the tone generator 22 of FIGS. 1 and 3. The output of the tone generator 22 is connected to one or more of the speakers 18.

The insertion of the video tape 24 into the VCR 14 causes a pivoted lever 26, pivoted around Point B, to rotate in a counterclockwise direction to permit the video tape 24 to be inserted into the VCR 14. In this position a switch 28 is not activated by the lever 26. In the load position a U-shaped flat spring 7 has its extension arm 7A flexed by the pivoted lever 26 while extension arm 7B remains unflexed.

Referring now to FIG. 2B, the video tape 24 has been completely inserted into the VCR 14. The pivoted lever 26 has repositioned to a vertical position by way of gravity, or as shown by the urging of the spring's extension arm 7A.

Referring to FIG. 2C, the video tape 24 is shown ejected causing the pivoted lever 26 top portion to tilt towards the switch 28 causing a closed condition on the switch. When the switch 28 is in the closed position, an audible warning signal is emitted by the speakers 18 as long as the video tape 24 remains in the VCR 14. Note the extension arm 7B is now flexed by the lower portion of the pivoted lever 26.

FIG. 3 depicts the wiring of the electronic tone generating circuit 22 which emits the warning tone to the switch 28 and to the speaker(s) 18. Once the video tape 24 has been removed the warning tone ceases because the pivoted lever 26 returns to the vertical position which allows switch 28 to open.

It is understood that pivoted lever 26 and the switch 28 in FIGS. 2A, 2B, and 2C could be replaced with a mechanical flag that would cause an electro-optical circuit to sense the position of the flag to initiate and control the generation of the warning tone. It is also understood that an optical signal, electromechanical signal, or any combination thereof could be used to control the start, duration, and operation of the warning tone in accordance with the position of the tape 24.

The invention has been described with reference to a preferred embodiment; However, it will be appreciated that variations and modifications can be effected by a person of ordinary skill in the art without departing from the scope of the invention.

### PARTS LIST

7 U-shaped flat spring 7A extension arm 7B extension arm 10 kiosk 14 VCR 16 activation device/switch assembly 18 speaker system 20 face plate assembly 22 tone generator 24 video tape 26 pivoted lever 28 switch

What is claimed is:

1. An audio warning device for use in conjunction with a tape player for providing a warning tone when a tape has not been removed from the tape player after the tape player has ejected the tape, comprising:
a tape player;
means for generating an audible tone when activated; and
activation means, in proximity to said tape player and responsive to the ejection of a tape from said tape player, for activating said audible tone generator when the tape is ejected from, but not removed from, the tape player.

2. The audio warning device according to claim 1 wherein said activation means is a switch assembly connected to activate said means for generating and an audible tone.

3. The audio warning device according to claim 2 wherein said switch assembly is comprised of:
a switch; and
a pivoted lever mounted such that one end is located in the path of any tape inserted and ejected from said tape player and the other end of which energizes said switch when the tape is ejected from said tape player.

4. The audio warning device according to claim 3 and further comprising:
spring means for urging said pivoted lever to a neutral position.

5. The audio warning device according to claim 4 wherein said spring means is a U-shaped flat spring.

6. The audio warning device according to claim 1 wherein said activation means is an electro-optical switch assembly.
